(19) United States
(12) Patent Application Publication
(10) Pub. No.: US 2012/0114403 A1
(43) Pub. Date: May 10, 2012

(54) CLEANING DEVICE AND IMAGE FORMING APPARATUS

(75) Inventor: Katsuya TAKENOUCHI, Kanagawa (JP)

(73) Assignee: FUJI XEROX CO., LTD., Tokyo (JP)

(21) Appl. No.: 13/152,074

(22) Filed: Jun. 2, 2011

(30) Foreign Application Priority Data
Nov. 10, 2010 (JP) 2010-251808

(51) Int. Cl. G03G 21/10

(52) U.S. Cl. 399/350

(57) ABSTRACT

A cleaning device includes a scrape-off member provided so as to contact an image carrying member, the scrape-off member scraping off powder adhered to a surface of the image carrying member; a net-like member provided between the contact portion of the scrape-off member and a duct, the net-like member trapping the scraped off powder by a flow of air; and the duct provided downstream from the net-like member in a direction of the flow of air, the duct sucking the air so as to guide the scraped off powder to the net-like member.

### CROSS-REFERENCE TO RELATED APPLICATIONS

This application is based on and claims priority under 35 USC 119 from Japanese Patent Application No. 2010-251808 filed Nov. 10, 2010.

### BACKGROUND

(i) Technical Field

The present invention relates to a cleaning device and an image forming apparatus.

(ii) Related Art

In an image forming apparatus, such as an electrophotographic copying machine, after a toner image is formed on the surface of an image carrying member, such as a photoconductor drum or an intermediate transfer belt, the toner image is transferred to, for example, a sheet of recording paper. At this time, residual toner may remain on the surface of the image carrying member because toner is not transferred to, for example, the sheet of recording paper. A foreign substance, such residual toner being a typical example, on the image carrying member prevents image formation from being properly performed.

### SUMMARY

According to an aspect of the invention, there is provided a cleaning device including a scrape-off member provided so as to contact an image carrying member, the scrape-off member scraping off powder adhered to a surface of the image carrying member; a net-like member provided between the contact portion of the scrape-off member and a duct, the net-like member trapping the scraped off powder by a flow of air; and the duct provided downstream from the net-like member in a direction of the flow of air, the duct sucking the air so as to guide the scraped off powder to the net-like member.

### BRIEF DESCRIPTION OF THE DRAWINGS

Exemplary embodiments of the present invention will be described in detail based on the following figures, wherein:

FIG. 1 is a schematic view of the structure of an image forming apparatus according to a first exemplary embodiment of the present invention;

FIG. 2 is a sectional view of a cleaning device according to the first exemplary embodiment of the present invention;

FIG. 3 is an oblique top view of a transporting member and a first filter holding member of the cleaning device;

FIG. 4 is a sectional view of the cleaning device that is not provided with a net-like member; and

FIG. 5 is a sectional view of a cleaning device according to a second exemplary embodiment of the present invention.

### DETAILED DESCRIPTION

Exemplary embodiments of the present invention will hereunder be described in detail with reference to the attached drawings.

### First Exemplary Embodiment

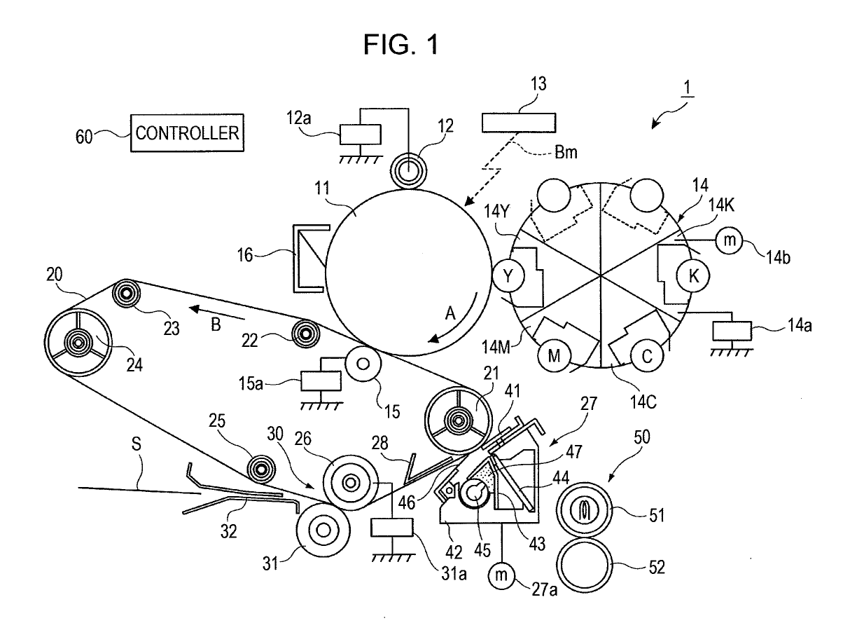

FIG. 1 is a schematic view of the structure of an image forming apparatus 1 according to a first exemplary embodiment of the present invention. The image forming apparatus 1 according to the exemplary embodiment includes a photoconductor drum 11, an intermediate transfer belt 20, a second transfer section 30, a fixing section 50, and a controller 60. The photoconductor drum 11 serves as an exemplary image carrying member and an exemplary first image carrying member disposed so as to be rotatable in the direction of arrow A. The intermediate transfer belt 20 serves as an exemplary second image carrying member disposed so as to be rotatable in the direction of arrow B, and carrying toner images of respective color components that are formed on the photoconductor drum 11 and that are successively transferred by first transfer operations to the intermediate transfer belt 20. The second transfer section 30 causes the superimposed toner images that are transferred to the intermediate transfer belt 20 to be transferred at one time to a sheet S (serving as an exemplary transferring material) by a second transfer operation. The fixing section 50 fixes the images transferred by the second transfer operation to the sheet S. The controller 60 controls each mechanical portion of the image forming apparatus 1.

Electrophotographic devices such as a charging roller 12, a laser exposure unit 13, a rotating developing device 14, a first transfer roller 15, and a reflesher 16 are successively disposed around the photoconductor drum 11. The charging roller 12 serves as an exemplary charging unit that charges the photoconductor drum 11. The laser exposure unit 13 (an illustrated exposure beam is indicated by Bm) serves as an exposure unit that forms an electrostatic latent image on the photoconductor drum 11. The rotating developing device 14 has developing units 14Y, 14M, 14C, and 14K rotatably mounted thereto. The developing units 14Y, 14M, 14C, and 14K serve as exemplary developing units that contain toners of respective color components (yellow (Y), magenta (M), cyan'(C), and black (K)) and that make visible the electrostatic latent image formed on the photoconductor drum 11 using the toners. The first transfer roller 15 serves as an exemplary transfer unit and an exemplary first transfer unit that transfers the toner images of the respective color components formed on the photoconductor drum 11 to the intermediate transfer belt 20. The reflesher 16 temporarily collects a portion of residual toner on the photoconductor drum 11 that is charged to a polarity that is opposite to a usual polarity.

The charging roller 12 is formed by, for example, forming an epichlorohydrin rubber layer on a surface of a metallic shaft and coating the surface of the epichlorohydrin rubber layer with polyamide to a thickness of 3 μm. The polyamide contains conductive powder of tin oxide. For example, the reflesher 16 is a brush formed by binding nylon fiber that has been made electrically conductive.

The photoconductor drum 11 is formed by forming an organic photosensitive layer on the surface of a thin cylindrical drum formed of metal. The organic photosensitive layer is formed of a material that is charged to a negative polarity. The rotating developing device 14 is capable of including six developing units. In FIG. 1, four of the developing units are developing units 14Y, 14M, 14C, and 14K. Developing operations by the developing units 14Y, 14M, 14C, and 14K are performed by a reversal development method. Therefore, toner serving as an exemplary powder used in the developing units 14Y, 14M, 14C, and 14K is of a type that is charged to a negative polarity. A charging bias power supply 12a for applying a charging bias is connected to the charging roller 12. A development bias power supply 14a for applying development bias to each of the developing units 14Y, 14M, 14C, and 14K is connected to the rotating developing device 14. A first transfer bias power supply 15a for applying a first transfer bias is connected to the first transfer roller 15. A developing device driving motor 14b for causing a predetermined developing unit to oppose the photoconductor drum 11 by rotation is mounted to the rotating developing device 14. The photoconductor drum 11 is connected to ground.

The intermediate transfer belt 20 is placed upon rollers (six in the exemplary embodiment) 21 to 26. The rollers 21 and 25 are driven rollers. The roller 22 is a metallic idle roller used in forming a flat first transfer surface or positioning the intermediate transfer belt 20. The roller 23 is a tension roller used for causing the tension of the intermediate transfer belt 20 to be constant. The roller 26 is a backup roller for second transfer (described later). The intermediate transfer belt 20 is formed of, for example, various kinds of rubber or resin (such as polyimide, polycarbonate, polyester, polypropylene, polyethylene terephthalate, acryl, or vinyl chloride) containing a suitable amount of carbon black. The intermediate transfer belt 20 has a surface resistivity of 10¹¹ Ω/square, a volume resistivity of 10¹¹ Ω·cm, and a thickness of 150 μm.

The second transfer section 30 serving as an exemplary second transfer section includes, for example, a second transfer roller 31, disposed at a toner image carrying surface side of the intermediate transfer belt 20, and the backup roller 26. The backup roller 26 is a tube formed of EPDM-NBR rubber blend in which carbon is dispersed at its surface. The interior of the backup roller 26 is formed of EPDM rubber. The backup roller 26 has a surface resistivity of 7 to 10 log Ω/square and a hardness of, for example, 70° (Asker C hardness). A second transfer bias power supply 31a for applying a second transfer bias is connected to the backup roller 26. The second transfer roller 31 is connected to ground. A sheet transporting guide 32 that guides a sheet S that is being transported to the second transfer section 30 is mounted to an upstream side of the second transfer section 30.

A cleaning device 27 serving as a belt cleaner that removes residual toner adhered to the intermediate transfer belt 20 after the second transfer is provided at a downstream side of the second transfer section 30. A plate member 28 is disposed along the inner surface of the intermediate transfer belt 20 at a location opposite to the cleaning device 27 with the intermediate transfer belt 20 being disposed between the plate member 28 and the cleaning device 27. The cleaning device 27 includes a cleaner housing 42 provided with a blade 41 serving as an exemplary scrape-off member that is formed of, for example, a urethane plate and that is disposed so that one end portion thereof contacts the image carrying surface side of the intermediate transfer belt 20. The other end portion of the blade 41 is secured to the cleaner housing 42 through a mechanism that is capable of adjusting the position of contact of the one end portion (front end portion) of the blade 41 with the intermediate transfer belt 20.

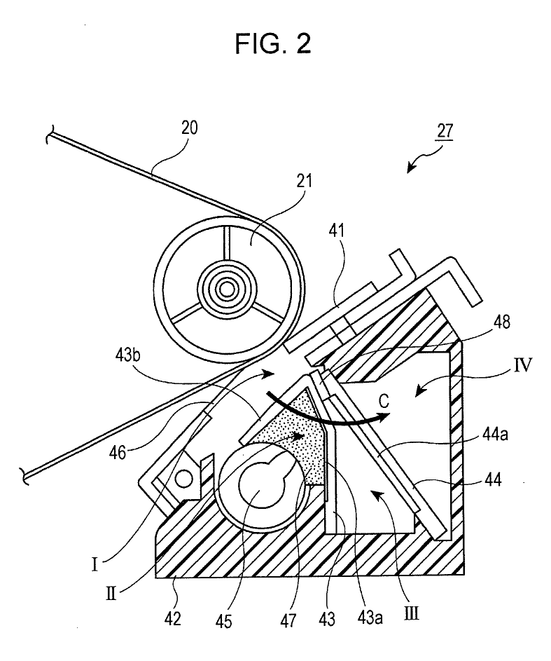

The cleaner housing 42 includes a first filter holding member 43 and a second filter holding member 44. The first filter holding member 43 has a first filter 43a (see FIG. 2 described later) mounted thereto. The second filter holding member 44 has a second filter 44a (see FIG. 2 described later) mounted thereto. The cleaner housing 42 also includes a transporting member 45 for discharging residual toner.

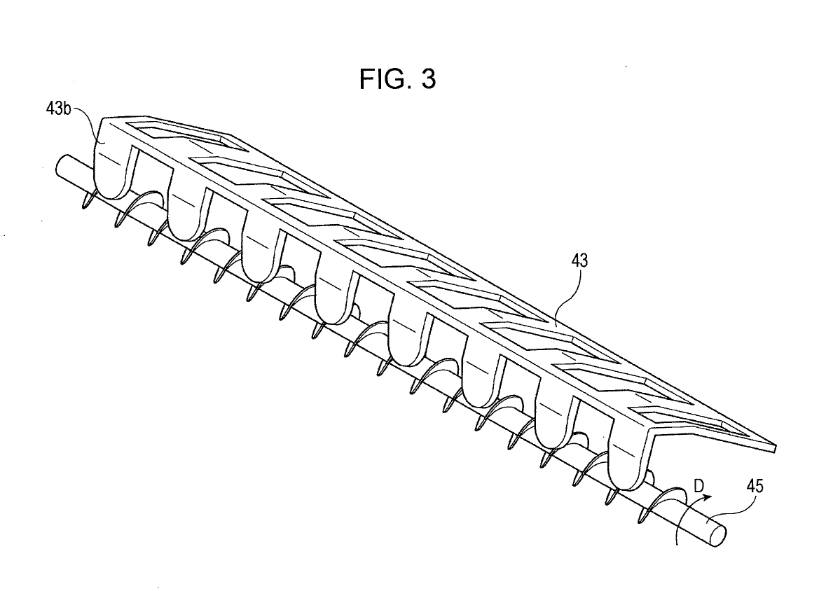

A front end angle of the first filter holding member 43 is an acute angle in cross sectional shape. As described later, one end portion includes lug portions 43b (see FIGS. 2 and 3 described later), with front end portions of the lug portions 43b contacting the transporting member 45.

The cleaner housing 42 further includes a net-like member 47 provided so as to fill a space surrounded by the first filter holding member 43 and the transporting member 45.

The cleaner housing 42 further includes a filter seal 46 at a location that is upstream from the blade 41 in the direction of movement of the intermediate transfer belt 20. The film seal 46 is used for suppressing flying of removed foreign substance to the outside. The film seal 46 is secured to the cleaner housing 42 through a mechanism that is capable of adjusting the position of contact of a front end thereof with the intermediate transfer belt 20.

By moving the cleaning device 27 with respect to the intermediate transfer belt 20 by a cam (not shown) connected to a cleaning device driving motor 27a, the blade 41 and the film seal 46 of the cleaner housing 42 are capable of contacting and separating from the intermediate transfer belt 20. In addition, in the exemplary embodiment, when a color image of multiple colors is to be formed, the second transfer roller 31 and the cleaning device 27 are separated from the intermediate transfer belt 20 until a toner image preceding a toner image of a final color passes the second transfer roller 31 and the cleaning device 27.

Further, the fixing section 50 includes a heating roller 51 and a pressure roller 52. The heating roller 51 has a heating source (such as a halogen lamp) built therein. The pressure roller 52 is disposed so as to press-contact the heating roller 51. By causing a sheet S to which a toner image is transferred to pass a fixing nip area formed between the heating roller 51 and the pressure roller 51, a fixing operation is performed.

Although not shown, the image forming apparatus 1 in a perpendicular direction to FIG. 1 has a continuous structure in at least the width of the sheet S.

Next, an image formation process by a color image forming apparatus according to an exemplary embodiment will be described. When a start switch (not shown) is turned on, the image formation process is executed. First, the surface of the photoconductor drum 11 is charged to a predetermined potential by the charging roller 12. Next, an electrostatic latent image corresponding to an image is formed using the laser exposure unit 13. The electrostatic latent image is developed by a corresponding one of the developing units 14Y, 14M, 14C, and 14K. For example, if the electrostatic latent image formed on the photoconductor drum 11 corresponds to yellow, the electrostatic latent image is developed by the developing unit 14Y containing yellow toner, so that a yellow toner image is formed on the photoconductor drum 11. The toner image formed on the photoconductor drum 11 is transferred from the photoconductor drum 11 to the intermediate transfer belt 20 by a first transfer bias applied to the first transfer roller 15 at a first transfer position where the photoconductor drum 11 and the intermediate transfer belt 20 contact each other. Residual toner on the photoconductor drum 11 after the first transfer operation is such that the reflesher 16 causes a portion thereof charged to an opposite polarity (that is, a positive polarity in the exemplary embodiment) to be removed, and to be made mechanically uniform.

At this time, when a monochromatic image is to be formed, the toner image that is transferred to the intermediate transfer belt 20 by the first transfer operation is immediately transferred to the sheet S by a second transfer operation. In contrast, when a color image is to be formed by placing toner images of multiple colors upon each other, a toner image formation operation at the photoconductor drum 11 and a first transfer process of a toner image formed on the photoconductor drum 11 are repeated in accordance with the number of colors. For example, when a full-color image is to be formed by placing toner images of four colors upon each other, a yellow toner image, a magenta toner image, a cyan toner image, and a black toner image are successively formed on the photoconductor drum 11, and the toner images of the respective colors are successively transferred to intermediate transfer belt 20 by first transfer operations. The intermediate transfer belt 20 rotates in the same period as the photoconductor drum 11 while holding the toner images transferred thereto by the first transfer operations. Accordingly, with every rotation of the intermediate transfer belt 20, the magenta toner image, the cyan toner image, and the black toner image are transferred to the intermediate transfer belt 20, and placed upon each other.

The toner images transferred to the intermediate transfer belt 20 by the first transfer operations in this way are transported to a second transfer position as the intermediate transfer belt 20 rotates. The sheet S is supplied to the second transfer position by the sheet transporting guide 32 at a predetermined timing by a registration roller (not shown). Then, the sheet S is nipped by the second transfer roller 31 with respect to the intermediate transfer belt 20 (the backup roller 26). When the sheet S is nipped, at the second transfer position, the toner images held by the intermediate transfer belt 20 are electrostatically transferred (that is, subject to second transfer operations) by the action of a second transfer electric field acting between the backup roller 26 and the second transfer roller 31 of the second transfer section 30. Thereafter, the sheet S having the toner images transferred thereto is transported to the fixing section 50. The toner images on the sheet S are fixed by heating and pressing the toner images. Any residual toner remaining on the intermediate transfer belt 20 that has passed the second transfer position is removed by the cleaning device 27.

That is, in the exemplary embodiment, the cleaning device 27 removes residual toner remaining on the intermediate transfer belt 20 serving as an image carrying member.

FIG. 2 is a sectional view of the cleaning device 27 according to the first exemplary embodiment of the present invention. As mentioned above, the cleaning device 27 includes the blade 41 and the film seal 46, mounted to the cleaner housing 42. The first filter holding member 43, the second filter holding member 44, and the transporting member 45 are provided in the cleaner housing 42.

The cleaning device 27 will be described in more detail with reference to FIG. 2.

As mentioned above, when a color image of multiple colors is to be formed, the blade 41 and the film seal 46 of the cleaning device 27 are separated from the intermediate transfer belt 20 until a toner image preceding a toner image of a final color passes the second transfer roller 31 and the cleaning device 27.

After the toner image that precedes the toner image of the final color passes the second transfer roller 31 and the cleaning device 27, the cleaning device 27 moves, so that the blade 41 and the film seal 46 contact the intermediate transfer belt 20.

The blade 41 is formed of, for example, a urethane plate, with its front end being rectangular in cross section. When an edge of the blade 41 contacts the intermediate transfer belt 20, residual toner is scraped off from the rotating intermediate transfer belt 20. Accordingly, the blade 41 is secured to the cleaner housing 42 through a mechanism that is capable of adjusting a pressing force of the blade 41 against the intermediate transfer belt 20.

The film seal 46 is formed of, for example, urethane. The film seal 46 contacts the intermediate transfer belt 20 to suppress flying of the residual toner scraped off by the blade 41 to the outside of the cleaning device 27. Accordingly, the film seal 46 is secured to the cleaner housing 42 through a mechanism that is capable of adjusting a pressing force of the film seal 46 against the intermediate transfer belt 20.

The cleaner housing 42 is formed of, for example, a plastic material.

The first filter holding member 43 whose front end angle is an acute angle in the cross sectional shape is formed of, for example, a plastic material. In FIG. 2, one end of the first filter holding member 43 includes multiple lug portions 43b in the perpendicular direction to FIG. 2. The front end of each lug portion 43b is in contact with the transporting member 45 (see FIG. 3 described later). The other end of the first filter holding member 43 holds the first filter 43a formed of, for example, a nonwoven cloth. The first filter holding member 43 is provided with multiple openings that allow air containing the residual toner to flow (see FIG. 3 described later).

The second filter holding member 44 is formed of, for example, a plastic material. The second filter holding member 44 holds the second filter 44a formed of, for example, a nonwoven cloth. The second filter holding member 44 is provided with multiple openings that allow air containing the residual toner to flow.

The transporting member 45 is a rotating member having a spiral blade provided around an axis thereof. When the transporting member 45 rotates, the spiral blade moves powder, liquid, etc. in an axial direction. Therefore, when the scraped off residual toner falls onto the transporting member 45, the scraped off residual toner is discharged from the cleaning device 27.

When the cleaning device 27 shown in FIG. 2 is viewed in cross section, the cleaning device 27 is divided into four cavities. That is, the cleaning device 27 includes a first cavity I, a second cavity II, a third cavity III, and a fourth cavity IV. The first cavity I is surrounded by the intermediate transfer belt 20, the blade 41, the film seal 46, and the lug portions 43b of the first filter holding member 43. The second cavity II is surrounded by a portion of the first filter holding member 43 that holds the first filter 43a and the lug portions 43b of the first filter holding member 43, and by the edge of the blade of the transporting member 45. The third cavity III is surrounded by a portion of the first filter holding member 43 holding the first filter 43a, the second filter holding member 44, and the cleaner housing 42. The fourth cavity IV is surrounded by the second filter holding member 44 and the cleaner housing 42.

In the first exemplary embodiment, the net-like member 47 is provided in the second cavity II. That is, the first filter holding member 43 also functions as a holding member that holds the net-like member 47.

The net-like member 47 is formed of, for example, a melamine foam having a void ratio that is substantially equal to or greater than 80%.

Here, the net-like member 47 has what is called a sponge structure, that is, a fine cell structure defined by a net-like skeletal structure. The net-like member 47 may be called a porous material. That is, the net-like member 47, which allows air to pass freely through cells (spaces) in the net-like skeletal structure, may be any net-like member as long as it allows powder, such as residual toner, that has flown in with the air to collide with and to be trapped by the net-like skeletal structure.

For the net-like member 47, for example, urethane foam may be used in addition to melamine foam.

FIG. 3 is an oblique top view of the transporting member 45 and the first filter holding member 43 of the cleaning device 27. The first filter holding member 43 includes the multiple lug portions 43b. The front end portion of each lug portion 43b contacts the blade of the transporting member 45. Therefore, when the transporting member 45 rotates in the direction of arrow D, the position of the front end of each lug portion 43b varies in accordance with the rotation of the transporting member 45. That is, when the front ends of the lug portions 43b are aligned with the blade of the transporting member 45, the first filter holding member 43 is moved upward at these portions. In contrast, when the front ends of the lug portions 43b separate from the transporting member 45, the first filter holding member 43 is moved downward at these portions.

That is, the portions of the first filter holding member 43 that are moved upward and downward by the rotation of the transporting member 45 move like a wave in a front-back direction (that is, in the axial direction of the transporting member 45). In other words, the first filter holding member 43 rocks by the rotation of the transporting member 45.

The movement of the first filter holding member 43 also rocks the net-like member 47 provided between the first filter holding member 43 and the transporting member 45.

As shown in FIG. 2, a damper 48, formed of, for example, urethane rubber, is provided between the first filter holding member 43 and the second filter holding member 44. Therefore, a gap is prevented from being formed between the first filter holding member 43 and the second filter holding member 44.

Next, the operation of the cleaning device 27 will be described with reference to FIG. 2.

The fourth cavity IV is a duct that sucks air, and has its pressure reduced by, for example, a pump. That is, air flows from the first cavity I to the fourth cavity IV through the second cavity II and the third cavity III in the direction of arrow C in FIG. 2.

When the blade 41 and the film seal 46 contact the intermediate transfer belt 20 by the movement of the cleaning device 27, the blade 41 scrapes off residual toner remaining on the intermediate transfer belt 20. At this time, since the first cavity I is surrounded by the intermediate transfer belt 20, the blade 41, and the film seal 46, the scraped off residual toner does not leak out of the cleaning device 27.

The scraped off residual toner flows on the air flow in the direction of arrow C, passes between the lug portions 43b of the first filter holding member 43, and enters the net-like member 47 provided in the second cavity II.

Here, as mentioned above, the net-like member 47 is formed of, for example, melamine foam having a void ratio that is substantially equal to or greater than 80%. Therefore, the net-like skeletal structure prevents the passage of residual toner, and traps the residual toner. However, since the void ratio is high, the net-like member 47 does not prevent the flow of air itself.

Since the transporting member 45 is rotating, the net-like member 47 is rocked by the first filter holding member 43. Melamine resin forming the net-like member 47 has good releasability, so that the melamine resin has small adhesive strength with respective to the residual toner. Therefore, the residual toner trapped in meshes of the net-like member 47 falls and settles in the net-like member 47, so that the residual toner is finally shaken off onto the transporting member 45. By shaking off the residual toner trapped in the net-like member 47, accumulation and clogging of the residual toner in the net-like member 47 are suppressed.

The scraped off residual toner is discharged in the axial direction of the transporting member 45 by the rotation of the transporting member 45.

The air containing the residual toner that has passed through the net-like member 47 passes through the first filter 43a and flows into the third cavity III. At this time, a portion of the residual toner is removed by the first filter 43a.

The air containing the residual toner that has passed through the first filter 43a passes through the second filter 44a and flows into the fourth cavity IV. At this time, a portion of the residual toner is removed by the second filter 44a.

As described above, not all the residual toner adheres to the net-like member 47 and is removed. Portions of the residual toner adhere to the first filter 43a and the second filter 44a, and are accumulated in the third cavity III and the fourth cavity IV.

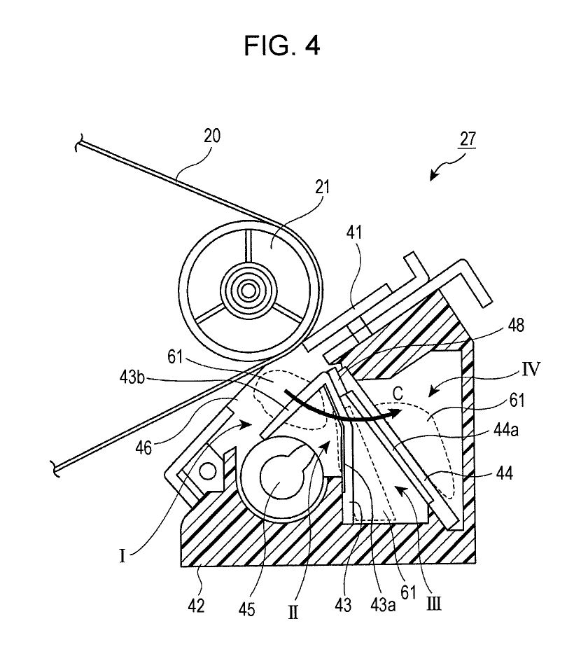

FIG. 4 is a sectional view of the cleaning device 27 that is not provided with the net-like member 47.

When the net-like member 47 is not provided, the residual toner on the intermediate transfer belt 20 is scraped off by the blade 41. A portion of the residual toner that has fallen onto the transporting member 45 due to gravity is discharged in the axial direction of the transporting member 45 by the rotation of the transporting member 45.

However, portions of the residual toner that do not fall onto the transporting member 45 and float in the air are removed by the first filter 43a and the second filter 44a. These portions of the residual toner accumulate on the first filter 43a and the second filter 44a and get clogged, and accumulate in the third cavity III and the fourth cavity IV, respectively, so that these portions of the residual toner become accumulated toners 61. The accumulated toners 61 prevent the flow of air in the direction of arrow C.

Finally, a state in which the flow of air in the direction of arrow C is completely prevented, and in which clogging occurs is reached. The residual toner scraped off by the blade 41 also accumulates in the first cavity I, and becomes accumulated toner 61. Then, a cloud of residual toner is blown out from the cleaning device 27. This causes the residual toner to be scattered in a wide area of the image carrying surface of the intermediate transfer belt 20 in the image forming apparatus 1.

To prevent this, it is necessary to set short the period of replacement of the cleaning device 27.

In the exemplary embodiment, as shown in FIG. 2, residual toner is caused to adhere to the net-like member 47 by a simple method of providing the net-like member 47 between the transporting member 45 that discharges the residual toner and a portion where the intermediate transfer belt 20 and the blade 41 that scrapes off the residual toner contact each other. This suppresses the amount of residual toner adhered to the first filter 43a and the second filter 44a and the amount of accumulated toners 61 in the third cavity III and the fourth cavity IV. This suppresses the hindering of the flow of air in the direction of arrow C, and the reduction in the cleaning performance of the cleaning device 27.

### Second Exemplary Embodiment

In the image forming apparatus 1 according to the first exemplary embodiment, the net-like member 47 in the cleaning device 27 is provided so as to fill the second cavity II formed by the first filter holding member 43 and the transporting member 45. In a cleaning device 27 of an image forming apparatus 1 according to a second exemplary embodiment, a net-like member 47 is provided at a portion (back side) of lug portions 43b of a first filter holding member 43. The other structural features are the same as those of the first exemplary embodiment, and will not be described below.

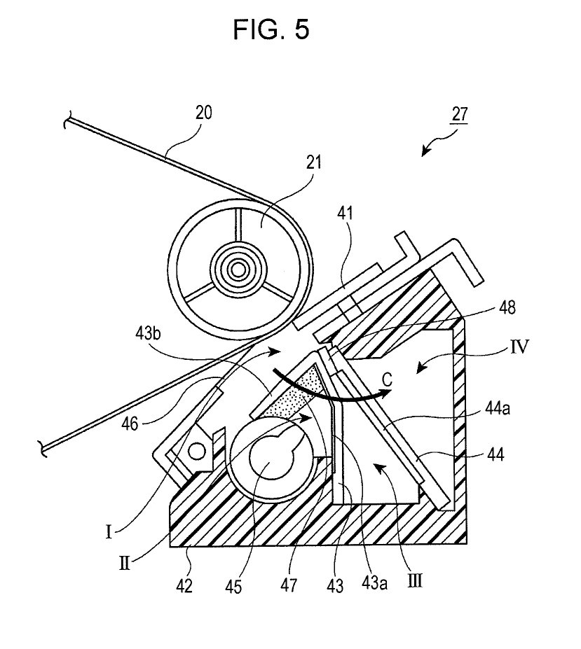

FIG. 5 is a sectional view of the cleaning device 27 according to the second exemplary embodiment of the present invention.

The net-like member 47 is provided at the inner sides of the lug portions 43b of the first filter holding member 43. Therefore, unlike the first exemplary embodiment, a second cavity II is not completely filled with the net-like member 47.

The net-like member 47 contacts a spiral blade edge of a transporting member 45 at a portion where each lug portion 43b of the first filter holding member 43 contacts the transporting member 45. The first filter holding member 43 also functions as a holding member that holds the net-like member 47.

As in the first exemplary embodiment, in the second exemplary embodiment, residual toner scraped off from an intermediate transfer belt 20 by a blade 41 of the cleaning device 27 passes through the net-like member 47 along an air flow in the direction of arrow C, and is trapped by a net-like skeletal structure of the net-like member 47. Similarly to the first exemplary embodiment, the net-like member 47 is rocked by the first filter holding member 43 as a result of the rotation of the transporting member 45, so that the residual toner trapped by meshes of the net-like member 47 falls onto the transporting member 45, and is discharged in the axial direction of the transporting member 45 by the rotation of the transporting member 45.

In the exemplary embodiment, since the net-like member 47 is provided at the back of the lug portions 43b of the first filter holding member 43, the distance of passage of air containing residual toner is smaller than that in the first exemplary embodiment. Therefore, in the second exemplary embodiment, the amount of residual toner trapped and removed by the net-like member 47 is smaller than that in the first exemplary embodiment. However, in the second exemplary embodiment, it is not necessary to provide a net-like member 47 that completely fills the second cavity II as it is in the first exemplary embodiment. Therefore, for example, a net-like member 47 formed into a plate is provided.

Although, in the first and second exemplary embodiments, the cleaning device 27 is described as a cleaning device of the intermediate transfer belt 20, the cleaning device 27 may be used as a drum cleaner that cleans the photoconductor drum 11.

The materials used in the first and second exemplary embodiments are examples. Other plastic materials or metal materials may be used in accordance with the purpose of use.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cleaning device comprising:
a scrape-off member provided so as to contact an image carrying member, the scrape-off member scraping off powder adhered to a surface of the image carrying member;
a net-like member provided between the contact portion of the scrape-off member and a duct, the net-like member trapping the scraped off powder by a flow of air; and
the duct provided downstream from the net-like member in a direction of the flow of air, the duct sucking the air so as to guide the scraped off powder to the net-like member.

2. The cleaning device according to claim 1, further comprising a transporting member provided below the net-like member of the cleaning device, the transporting member serving as a rotating member that discharges the powder trapped by the net-like member and falling from the net-like member, and that includes a spiral blade around a rotating axis thereof.

3. The cleaning device according to claim 2, wherein the net-like member being held by a first holding member, the holding member extends along the rotating axis, an end portion of the first holding member in a lateral direction contacts an edge of the spiral blade of the transporting member partially, an edge of the end portion having a diminished cross-sectional shape.

4. The cleaning device according to claim 3, wherein the end portion includes a plurality of lug portions in a longitudinal direction of the first holding member, each end of lug portion is in contact with the edge of the spiral blade.

5. The cleaning device according to claim 3, further comprising a first filter member that being held by other end portion of the first holding member and provided downstream from the net-like member in a direction of the flow of air, the other end portion being provided with a plurality of openings that allow air to flow.

6. The cleaning device according to claim 5, wherein the net-like member fills a space between the transporting member and the first filter member.

7. The cleaning device according to claim 5, further comprising a second filter member that being held by a second holding member and provided downstream from the first filter member in a direction of the flow of air, the second holding member being provided with a plurality of openings that allow air to flow.

8. The cleaning device according to claim 1, wherein the net-like member is a foam having an open cell structure.

9. The cleaning device according to claim 8, wherein the net-like member is formed of melamine foam.

10. The cleaning device according to claim 8, wherein a void ratio of the net-like member is substantially equal to or greater than 80% and less than 100%.

11. An image forming apparatus comprising:
an image carrying member;
a charging unit that charges the image carrying member;
an exposure unit that exposes the image carrying member charged by the charging unit;
a developing device that develops an electrostatic latent image formed on the image carrying member by the exposure using the exposure unit;
a transfer unit that transfers the developed image on the image carrying member to a transferring material; and
a cleaning device according to claim 1.

12. An image forming apparatus comprising:
a first image carrying member;
a charging unit that charges the first image carrying member;
an exposure unit that exposes the first image carrying member charged by the charging unit;
a developing device that develops an electrostatic latent image formed on the first image carrying member by the exposure using the exposure unit;
a first transfer unit that transfers the developed image on the first image carrying member to a second image carrying member;
a second transfer unit that transfers the image transferred to the second image carrying member to a transferring material; and
a cleaning device according to claim 1.
